(19) United States
(12) Patent Application Publication
(10) Pub. No.: US 2006/0229400 A1
(43) Pub. Date: Oct. 12, 2006

(54) Powder coating matting agent comprising ester amide condensation product

(76) Inventor: Tim Fletcher, Worms (DE)

Correspondence Address: GRACE GMBH & CO. KG, 7500 GRACE DRIVE, COLUMBIA, MD, 21044, US

(21) Appl. No.: 10/516,196

(22) PCT Filed: May 23, 2003
(86) PCT No.: PCT/EP03/05413

§ 371 Date: Aug. 18, 2005

(30) Foreign Application Priority Data
May 31, 2002 (EP) 01012053.1

(51) Int. Cl. C08K 3/22

(52) U.S. Cl. 524/430; 528/310

(57) ABSTRACT

The compounds of this invention are suitable matting agents for powder coatings. The compounds are ester amide-containing condensation products optionally comprising at least one β-hydroxyalkylamide functional group and, for example, are prepared from monomeric ester-amides, oligomeric polyester-amides or polymeric polyester-amides bearing β-hydroxyalkylamide groups by reacting the hydroxyalkylamide bearing ester amide with another compound such that at least one reactive functional group other than β-hydroxyalkylamide is also present on the condensation product, and further such that 50% or more of the terminal β-hydroxyalkylamide functionality has been reacted or converted to groups containing terminal carboxylic acid groups or other reactive groups including, but not limited to, groups reactive with polymers and crosslinkers suitable for preparing epoxy, epoxy-polyester, polyerster, polyester acrylic, polyester-primid, poylurethane or acrylic powder coatings. Other embodiments of the invention comprise the combination of the aforementioned condensation product with inorganic solids such as silicas and aluminas, and/or matte activators.

### BACKGROUND

This invention relates to products suitable for use as a matting agent in powder coating formulations, and in particular condensation products containing at least one ester amide, optionally at least one β-hydroxyalkylamide group, and at least one reactive functional group other than a β-hydroxyalkylamide.

Powder coatings, and in particular thermosetting powder coatings, are part of a rapidly growing sector in the coatings industry. These coatings are known for their glossy appearance and have the benefit of not containing volatile solvent.

Compounds containing β-hydroxyalkylamide groups have been disclosed in the patent literature for purposes of preparing polymers and crosslinkers for surface coatings. Particularly mentioned are water-borne coatings and powder coatings. U.S. Pat. No. 4,076,917 describes glossy powder coatings based on β-hydroxyalkylamide chemistry.

Primid XL552 from Rohm&Haas is an example of a β-hydroxyalkylamide-based crosslinker. It has been used with increasing success in curing carboxyl bearing polyester-based resins to produce glossy powder coatings. Such powder coatings are generally intended for outdoor use. Compounds such as Primid XL552 can be obtained by the reaction of di-esters of carboxylic acids with aminoalcohols such as those disclosed in U.S. Pat. No. 4,076,917. A typical example would be the dimethylester of adipic acid reacted with diethanolamine or disopropanolamine.

U.S. Pat. No. 3,709,858 refers to polyester-amide based coatings prepared from polymers containing terminal and pendant β-hydroxyalkylamide groups and also terminal and pendant carboxylic groups for use in the preparation of coatings. Particularly mentioned are water-borne coatings, and the polymers can be considered as capable of self-curing at elevated temperatures. The polymers are obtained by condensing polyols and polyacids and the β-hydroxyalkylamide chemistry arises from the use of N,N-bis[2-hydroxyalkyl]-2-hydroxyethoxyacetamide as a monomer. The polymers can be linear or branched.

In addition to the reaction products of saturated or unsaturated monomeric di-esters of carboxylic acids with aminoalcohols as monomeric crosslinkers for polymers bearing one or more carboxylic or anhydride functions, U.S. Pat. No. 4,076,917 further discloses polymers containing pendant β-hydroxyalkylamide groups as crosslinkers and self-curing polymers containing both β-hydroxyalkylamide groups and carboxylic acid groups. Acrylate based polymers were specifically discussed where copolymerization with β-hydroxyalkylamide compounds containing vinyl groups was performed. Patents relating to these latter aspects are U.S. Pat. No. 4,138,541; U.S. Pat. No. 4,115,637; and U.S. Pat. No. 4,101,606. EP 322 834 describes powder coating compositions obtained by crosslinkers of the type given in U.S. Pat. No. 4,076,917 with carboxylic acid bearing polyester resins.

U.S. Pat. No. 5,589,126 discloses linear or branched amorphous or semi-crystalline copolyesters of molecule weight between 300 and 15000 containing two or more terminal β-hydroxyalkylamide groups for use as crosslinkers with carboxylic acid bearing polymers such as are employed in powder coatings. Hydroxy numbers are between 10 and 400 mg KOH/g. The polymers are obtained by producing hydroxyl terminated polyesters, esterification with diesters of carboxylic acids and subsequent reaction with aminoalcohols.

WO 99/16810 describes linear or branched polyester-amides having a weight average molecular weight of not less than 800 g/mol where at least one amide group is in the polymer backbone and having at least one terminal β-hydroxyalkylamide group. The polymers may be entirely or partly modified with monomers, oligomers or polymers containing reactive groups that can react with β-hydroxyalkylamide groups where crosslinking is preferably avoided by using monomers, oligomers or polymers that contain only one group that can react with the β-hydroxyalkylamide group e.g. monofunctional carboxylic acids. The polymers may be obtained by reaction of a cyclic anhydride with an aminoalcohol with subsequent polycondensation between the resulting functional groups.

It is mentioned in WO 99/16810 that it is surprising that the polyester-amides disclosed are capable of giving good flow and film properties in powder coatings because previous use of reactive polymers having functionality greater than 6 in powder coatings are normally associated with poor appearance and poor film properties. The terminal β-hydroxyalkylamide groups accordingly are modified to an extent less than 50% and preferably less than 30%.

WO 01/16213 describes a process to prepare polymers similar to those described in WO 99/16810, but that process involves reacting a polycarboxylic acid with an aminoalcohol followed by polycondensation in order to produce a polymer employed as a crosslinker that does not release cyclic anhydrides when acid functional polyesters such as those used in powder coatings are cured.

The above references describe chemistries primarily designed to improve powder coatings exhibiting glossy finishes and are for the most part silent towards modifying those formulations to obtain flat or matted finishes. Indeed, there is considerable interest in matte powder coatings which retain the good film properties of their glossy counterparts.

Solid particles such as silicas, carbonates and talcs are widely used to matt conventional non-powder coatings. Matting conventional coatings, however, depends on the coating layer shrinking in thickness during film formation due to solvent release or release of water in the case of water-borne coatings. An absence of such solvents and the accompanying significant shrinkage renders this approach a relatively ineffective method of matting powder coatings.

Waxes have also been used in matting agents for conventional coatings and have on occasion been employed alone or in combination with fillers to reduce gloss in powder coatings. This approach, however, is not very effective and a greasy surface due to exudation of the wax can result depending on the extent the wax is incompatible with the polymeric component of the powder coating.

The limited success of conventional matting agents thus has led to the development of a number of new matting mechanisms for powder coatings. For example, it has been shown that powder coatings can be matted by (1) dry blending powders having different reactivity or flow capability, (2) co-extruding two powder coating compositions having different reactivity or even different reactive chemistry, (3) adding special curing agents having limited compatibility with the powder coating polymer, (4) use of polymer binders having a high degree of branching with reactive end-groups, and (5) crosslinkers bearing two types of functional groups capable of participating in reaction with polymers or polymer blends having different functional groups, each of which is reactive with one or other of the functional groups associated with the crosslinker. The last two examples have been used with polyurethane powder coatings, while the first three mentioned have been used with epoxy, polyester-epoxy and polyurethane coatings. Matting of polyester powder coatings tends to rely on the use of dry blends.

It is apparent that although low values of gloss below 20 at 60° can be obtained using current matting products or techniques in specific formulations of a given powder coating type, it has often been difficult to retain other desirable film properties such as flexibility, hardness, solvent resistance, outdoor durability and resistance to yellowing during film cure. It is therefore an object of this invention to obtain matting agents which can generate acceptable matte finishes, but at the same time maintain other desirable film properties. It is also a goal to provide a method in which conventional matting agents can still be used in the matting agent, yet attain acceptable matte finishes, as well as maintain those desirable film features mentioned above.

### BRIEF DESCRIPTION OF DRAWINGS

FIG. 1 illustrates a method for making β-hydroxyalkylamide compounds and subsequent reactions with a compound having functional groups other than β-hydroxyalkylamide for making a condensation product of this invention.

FIG. 2 illustrates an alternate process for preparing condensation product of this invention.

FIG. 3 illustrates viscoelastic data of a conventional polyester powder coating during curing where the crosslinker is a conventional hydroxyalkylamide crosslinker.

### SUMMARY OF THE INVENTION

The compounds of this invention are ester amide-containing condensation products comprising, optionally, at least one β-hydroxyalkylamide functional group, and at least one reactive functional group other than a β-hydroxyalkylamide group. Such products can be prepared from monomeric ester-amides, and linear or branched, oligomeric polyester-amides or polymeric polyester-amides. The condensation product of this invention, however, is reacted such that 50% or more of the terminal β-hydroxyalkylamide functionality has been converted to groups containing terminal or pendent carboxylic acid groups or other desirable functional groups with respect to the nature of the powder coating that is to be matted. The total functionality is at least two functional groups (identical or different) per molecule.

Preferred functional groups of this invention comprise carboxylic acid groups, or carboxylic acid groups in combination with β-hydroxyalkylamide groups where the latter are present to an extent of no more than 50% of the total functionality on a mole basis. These compounds are compatible with and reactive with many types of polymers typically employed in powder coatings. Given the reactivity of the β-hydroxyalkylamide group, other reactive groups can be readily introduced depending on the specific powder coating to be matted. Other reactive groups include, but are not limited to, those reactive with epoxy, polyester, epoxy-polyester, polyester-primid, polyurethane, and acrylic polymers which are employed as binders in typical powder coatings.

Another embodiment of the invention comprises the combination of the aforementioned condensation product with inorganic solids such as silicas, aluminas, silicates and aluminosilicates. Such combinations can provide additional control over the rheological processes occurring during film formation, thereby leading to enhanced matting, easier handling of the organic condensation product component from a health and safety point of view and easier incorporation of the organic component into a powder coating in case the desirable organic component in question is liquid or semi-solid. Additionally, milling of the organic component in the presence of an inorganic solid to a suitable particle size can be more conveniently carried out, and the latter's use can result in a product which can be incorporated into the powder coating with relative ease and uniformity.

Another embodiment comprises combining the condensation product with a matte activator, e.g., a suitable catalyst or coreactant for the powder coating binder. These embodiments showed improved matting and film properties over those in which the condensation product is employed without, e.g., a catalyst or coreactant.

As indicated above, the condensation products of the invention are prepared by reacting an ester, or an ester-amide, bearing terminal or pendent β-hydroxyalkylamide groups, with another compound bearing the other reactive functional groups, or acting as a precursor to other reactive functional groups, or acting as a precursor in the sense that the other reactive groups arise from further reactions which may include polymerisation reactions. The two components, however, are reacted such that the gel point is not reached or exceeded during manufacture. It has been found that when the total functionality or average number of functional groups per molecule of the condensation product exceeds four, the product imparts a matting effect to powder coatings.

### DETAILED DESCRIPTION

β-hydroxyalkylamide

The condensation product of this invention is prepared from compounds bearing terminal β-hydroxyalkylamide groups. Ester-amide compounds bearing terminal β-hydroxyalkylamide groups are in general known, e.g., Primid® additives from Rhom & Haas, and examples of methods for making such compounds are disclosed in U.S. Pat. Nos. 4,076,917; 3,709,858; U.S. Pat. No. 5,589,126 and WO 99/16810 the contents of which are incorporated herein by reference.

Thus, compounds bearing terminal β-hydroxyalkylamide groups can for example be prepared from the reaction between (1) monomeric dialkyl ester derivatives of dicarboxylic acids and (2) β-aminoalcohols, which may in general be monoalkanolamines, dialkanolamines or trialkanolamines.

In a variant of this method, oligomeric or polymeric substances containing on average two or more terminal ester groups can be used in place of the monomeric diester. These oligomeric or polymeric species may be obtained by transesterification of monomeric or polymeric polyols with a suitable excess of a monomeric diester. Subsequent reaction of these oligomeric or polymeric species with a suitable aminoalcohol results in a compound containing two or more β-hydroxyalkylamide groups. The actual number of groups will of course depend on whether a monoalkanolamine, a dialkanolamine or a trialkanolamine is used.

The species containing terminal ester groups may be replaced with derivatives of monomeric cyclic anhydrides or polyanhydrides. In this case, an addition reaction between the anhydride and aminoalcohol takes place to produce a monomeric compound bearing carboxylic acid groups and β-hydroxyalkylamide groups. In a further reaction step, this monomeric compound may be polymerised by a condensation reaction between the carboxylic acid groups and β-hydroxyalkylamide groups to produce a polymeric compound bearing at least one terminal β-hydroxyalkylamide group. The number of β-hydroxyalkylamide groups remaining after such a reaction depends on whether monoalkanolamines, dialkanolamines or trialkanolamines are employed and also on whether the anhydride is a monoanhydride or a polyanhydride.

Whether obtained by the reaction of an ester with an aminoalcohol or an anhydride with an aminoalcohol, it is apparent that a compound bearing terminal β-hydroxyalkylamide groups may itself act as a polyol. It may also be reacted with a suitable excess of a monomeric diester to produce species containing on average one or more terminal alkyl ester groups for further reaction with aminoalcohols.

Oligomeric or polymeric substances bearing ester groups mentioned above as suitable for manufacturing the hydroxyalkylamide compounds can be obtained by transesterification of monomeric alkyl esters of di- or polyfunctional carboxylic acids with di- or polyfunctional alcohols in either melt form or in solvent at a temperature in the range of 50° C. to 275° C. in the presence of suitable catalysts, such as, for example, metal carboxylates like zinc acetate, manganese acetate, magnesium acetate or cobalt acetate as well as metal alkoxides like, tetraisopropyl titanate, or sodium methoxide.

Oligomeric or polymeric derivatives bearing terminal ester groups can also be obtained by a conversion reaction of hydroxyl-functional polyesters with monomeric alkylesters of di- or polycarboxylic acids, either in melt form or in suitable solvents at a temperature in the range of 50° C. to 275° C. in the presence of suitable catalysts.

Hydroxyl-functional polyesters may be obtained by conventional polymerization techniques involving di- and polyfunctional carboxylic acids with di- and polyfunctional alcohols. Hydroxyl-functional polyesters with on average a higher degree of branching may be obtained if required by polymerisation of suitable polyhydroxycarboxylic acids according to methods described for example in U.S. Pat. No. 3,669,939, U.S. Pat. No. 5,136,014 and U.S. Pat. No. 5,418,301, the contents of which are incorporated by reference.

Hydroxy-functional polyesters can also be prepared via esterification and ester interchange reactions or via ester interchange reactions. Suitable catalysts for those reactions include, as an example, dibutyl tin oxide or titanium tetrabutylate.

Suitable hydroxy-functional polyester resins have a hydroxyl value of 10-500 mg KOH/g.

The monomeric alkyldiesters of polycarboxylic acids indicated in the above reactions include dimethyl terephthalate, dimethyl adipate and dimethylhexahydroteraphthalate.

Examples of suitable di- and polyfunctional carboxylic acid components in the above reactions include, but are not limited to, aromatic multi-basic carboxylic acids such as terephthalic acid, isophthalic acid, phthalic acid, pyromellitic acid, trimellitic acid, 3,6-dichlorophthalic acid, tetrachlorophathalic acid, and their anhydride, chloride or ester derivatives, together with aliphatic and/or cycloaliphatic multi-basic acids such for example as 1,4-cyclohexanedicarboxylic acid, tetrahydrophthalic acid, hexahydroendomethylene terephthalic acid, hexachlordphthalic acid, C₄-C₂₀ dicarboxylic acids such as, for example, azelaic acid, sebacic acid, decandicarboxylic acid, adipic acid, dodecandicarboxylic acid, succinic acid, maleic acid, as well as dimeric fatty acids and their anyhdride, chloride and ester derivatives. Hydroxycarboxylic acids and/or lactones such as, for example, 12-hydroxystearic acid, epsilon-Caprolacton or hydroxypivalic acid ester of neopentyl glycol, can likewise be used. Monocarboxylic acids, such as, for example, benzoic acid, tertiary butylbenzoic acid, hexahydrobenzoic acid and saturated aliphatic monocarboxylic acids may also be used as required.

The following aliphatic diols are named by way of example of suitable difunctional alcohols mentioned above: ethylene glycol, 1,3-propanediol, 1,2propanediol, 1,2butanediol, 1,3-butanediol, 1,4butanediol, 2,2-dimethylpropane1,3-diol (neopentyl glycol), 2,5-hexandiol, 1,6-hexandiol, 2,2-[bis-(4hydroxycyclohexyl)]propane, 1,4dimethylolcyclohexane, diethylene glycol, dipropylene glycol and 2,2-bis-[4-(2-hydroxy)]phenyl propane.

Suitable polyfunctional alcohols mentioned above are glycerol, hexanetriol, pentaeryltritol, sorbitol, trimethylolethane, trimethylolpropane and tris(2-hydroxy)isocyanurate. Epoxy compounds can be used instead of diols or polyols. Alkoxylated diols and polyols are also suitable.

2,2-bis-(hydroxymethyl)-propionic acid, 2,2-bis-(hydroxymethyl)-butyric acid, 2,2-bis-(hydroxymethyl)-valeric acid, 2,2,2-tris-(hydroxymethyl)-acetic acid and 3,5.dihydroxybenzoic acid may be mentioned as examples of polyhydroxylcarboxylic acids.

In all of the above, previously prepared compounds containing terminal β-hydroxyalkylamide groups may also be employed instead of or in addition to the above mentioned di- and polyfunctional alcohols.

In all of the above, mixtures of various polyols, polybasic carboxylic acids and hydroxyl- and polyhydroxylcarboxylic acids or mixtures of their corresponding oligomers or polymers and their corresponding ester terminated analogues can be used.

In the above, the ratio of ester groups to hydroxyl groups in the conversion reaction between the diester and the hydroxyl bearing substance varies with the nature of the polyol, its functionality, the desired material and the need to avoid gelation. If for example the average functionality of the polyol is three, the minimum proportion of polyol to diester is such that the ratio of hydroxyl to ester groups is 0.5. If the average functionality of the polyol is six, the minimum proportion of polyol to diester is such that the ratio of hydroxyl to ester groups is 0.3

As mentioned above, derivatives of monomeric cyclic anhydrides or polyanhydrides can be used instead of diester derivatives to prepare the -hydroxylalkylamide compound.

A preferable cyclic anhydride is a mono anhydride according to formula I: 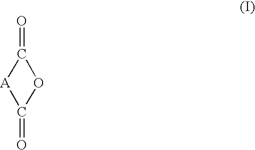
in which A has the meaning specified later below.

Examples of suitable cyclic anhydrides include phthalic anhydride, tetrahydrophthalic anhydride, naphtalenic dicarboxylic anhydride, hexahydrophthalic anhydride, 5-norbornene-2,3-dicarboxylic anhydride, norbornene-2,3-dicarboxylic anhydride, naphtalenic dicarboxylic anhydride, 2-dodecene-1-yl-succinic anhydride, maleic anhydride, (methyl)succinic anhydride, glutaric anhydride, 4-methylphthalic anhydride, 4-methylhexahydrophthalic anhydride, 4-methyltetrahydrophthalic anhydride and the maleinised alkylester of an unsaturated fatty acid.

Preferably the aminoalcohol reactive with the ester or anhydride is a compound according to the Formula II: 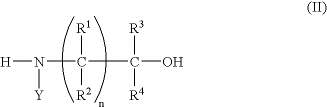
in which: 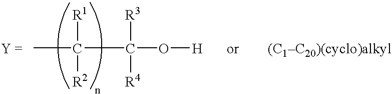
R¹, R², R³, and R⁴ may, independently of one another, be the same or different, and includes, but is not limited to, H, or substituted or unsubstituted alkyl (linear or branched), (C₆-C₁₀) aryl (C₁-C₂₀)(cyclo)alkyl radical. Generally n=1-4, but more preferably, n=1.

The aminoalcohol may be a monoalkanolamine, a dialkanolamine, a trialkanolamine or a mixture hereof.

Dialkanolamines are preferred, but if monoalkanolamines are used in the reaction with cyclic anhydrides, in order to obtain polymers bearing β-hydroxyalkylamide groups with a functionality of 2 or greater, polyanhydrides would need to be employed so as to provide sufficient functionality to produce a final product having the desired functionality. Similarly, if monoalkanolamines are employed in the reaction with oligomeric or polymeric substances bearing ester groups, the substances would need an average functionality of at least two ester groups to produce polymers bearing β-hydroxyalkylamide groups with a functionality of 2 or greater.

If a highly branched structure with relatively high functionality is desired, di- or trialkanolamines can be used.

Overall therefore, depending on the application desired, a linear or an entirely or partly branched oligomer or polymer bearing β-hydroxyalkylamide groups can be chosen, in which further moderation of the structure can be attained via the alkanolamines selected for preparation of the desired oligomer or polymer.

Examples of suitable mono-o-alkanolamines include 2-aminoethanol(ethanolamine), 2-(methylamino)-ethanol, 2-(ethylamino)-ethanol, 2-(butylamino)-ethanol, 1-methyl ethanolamine(isopropanolamine), 1-ethyl ethanolamine, 1-(m)ethyl isopropanolamine, n-butylethanolamine, β-cyclohexanolamine, n-butyl isopropanolamineand 2-Amino-1-propanol,.

Examples of suitable di-o-alkanolamines are diethanolamine (2,2′-iminodiethanol), 3-amino-1,2-propanediol, 2-amino-1,3-propanediol, diisobutanolamine (bis-2-hydroxy-1-butyl)amine), di-β-cyclohexanolamine and diisopropanolamine(bis-2-hydroxy-1-propyl)amine).

A suitable trialkanolamine is, for example, tris(hydroxymethyl)aminomethane.

In a number of instances, alkanolamines with β-alkyl-substitution are preferably used. Examples are (di)isopropanolamine, cyclohexyl isopropanolamine, 1-(m)ethyl isopropanolamine, (di)isobutanolamine, di-β-cyclohexanolamine and/or n-butyl isopropanolamine.

The ester:alkanolamine amine equivalent ratio is generally, in the range of 1:0.5 to 1:1.5 and more typically in the range of 1:0.8 to 1:1.2.

The anhydride:aminoalcohol equivalent ratio is dependent upon the anhydride, but generally is between 1.0:1.0 and 1.0:1.8. Preferably, this ratio is between 1:1.05 and 1:1.5.

When an anhydride is reacted with an aminoalcohol, the reaction can be carried out by reacting the anhydride and aminoalcohol at a temperature between, for example, about 20° C. and about 100° C., to form a substantially monomeric hydroxyalkylamide, after which, at a temperature between, for example, 120° C. and 250° C., a polyesteramide is obtained through polycondensation with water being removed through distillation.

Excess aminoalcohol may be required when employing this procedure to regulate molecular weight build-up. Alternatively, use of a monofunctional β-hydroxyalkylamide group containing compound or monofunctional carboxylic acid compound to moderate the functionality may be employed depending on the final compound desired. A further moderating procedure, which may be used separately or in combination with the previously mentioned options is to employ a compound containing 2 or more β-hydroxyalkylamide groups, but no other reactive group capable of reacting with a β-hydroxyalkylamide group. These are similar techniques to those employed to prepare polyesters with terminal hydroxyl groups with varying degrees of branching such as is for example described in U.S. Pat. No. 5,418,301, the contents of which are incorporated by reference.

When an ester containing compound is reacted with an aminoalcohol, the reaction can be carried out at a temperature between 20° C. and 200° C., more typically 80° C. to 120° C., optionally in the presence of suitable catalysts such as metal hydroxides, metal alkoxides, quaternary ammonium hydroxides and quaternary phosphonium compounds. The alcohol arising from the reaction is removed by distillation. The proportion of catalyst may typically range from 0.1% to 2% by weight.

The reactions can take place in a melt phase, but also in water or in an organic solvent.

The removal of water or alcohol through distillation can take place at a pressure higher than 1 bar, under reduced pressure, azeotropically under normal conditions of pressure, with co-distillation of solvent or with the aid of a gas flow.

Using derivatives discussed above, specific β-hydroxyalkylamides according to the Formula (III) below can be prepared: 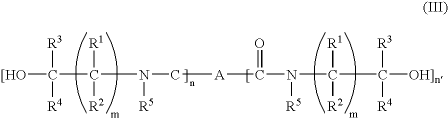
wherein A is a bond, hydrogen or a monovalent or polyvalent organic radical derived from a saturated or unsaturated alkyl radical wherein the alkyl radical contains from 1-60 carbon atoms, such as methyl, ethyl, propyl, butyl, pentyl, hexyl, heptyl, octyl, nonyl, decyl, eicosyl, triacontyl, tetracontyl, pentacontyl, hexylcontyl and the like; substituted or unsubstituted aryl, for example, C₂-C₂₄ mono- and dinuclear aryl such as phenyl, naphthyl and the like; C₁-C₈ cycloalkyl, diradical, tri-lower alkyleneamino such as trimethyleneamino, triethyleneamino and the like; or an unsaturated radical containing one or more ethylenic groups [>C═C<] such as ethenyl, 1-methylethenyl, 3-butenyl-1,3-diyl, 2-propenyl-1,2-diyl, carboxy lower alkenyl, such as 3-carboxy-2-propenyl and the like; lower alkoxy carbonyl lower alkenyl such as 3-methoxycarbonyl-2-propenyl and the like.

R⁵ is hydrogen, alkyl, preferably of from 1-5 carbon atoms such as methyl, ethyl, n-propyl, n-butyl, sec-butyl, tert-butyl, pentyl and the like or hydroxy lower alkyl preferably of from 1-5 carbon atoms such as hydroxyethyl, 3-hydroxypropyl, 2-hydroxypropyl, 4-hydroxybutyl, 3-hydroxybutyl, 2-hydroxy-2-methylpropyl, 5-hydroxypentyl, 4-hydroxypentyl, 3-hydroxypentyl, 2-hydroxypentyl and the isomers of pentyl; R⁵ can also be Y in Formula II above.

R¹, R², R³ and R⁴ preferably are the same or different radicals selected from hydrogen, straight or branched chain alkyl, preferably of from 1-5 carbon atoms, or R¹ and R³ or R² and R⁴ radicals may be joined to form, together with the carbon atoms, a C₃-C₂₀ such as cyclopentyl, cyclohexyl and the like; m is an integer having a value of 1 to 4; n is an integer having a value of 1 or 2 and n′ is an integer having a value of 0 to 2. When n′ is 0, A can be a polymer or copolymer (i.e., n has a value greater than 1 preferably 2-12) formed from the β-hydroxyalkylamide when A is an unsaturated radical.

More specific compounds are those of the foregoing Formula III, wherein R⁵ is H, lower alkyl, or HO(R³)(R⁴)C(R¹)(R²)C—, n and n′ are each 1, -A- is —(CH₂)ₘ—, m is 0-8, preferably 2-8, each R group is H, and one of R³ or R⁴ radicals in each case is H and the other is H or a C₁-C₅ alkyl; that is, of formula (IV) 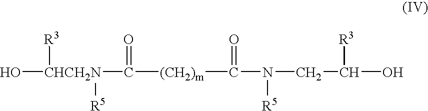
(wherein R⁵, R³, and m have the meanings given above.

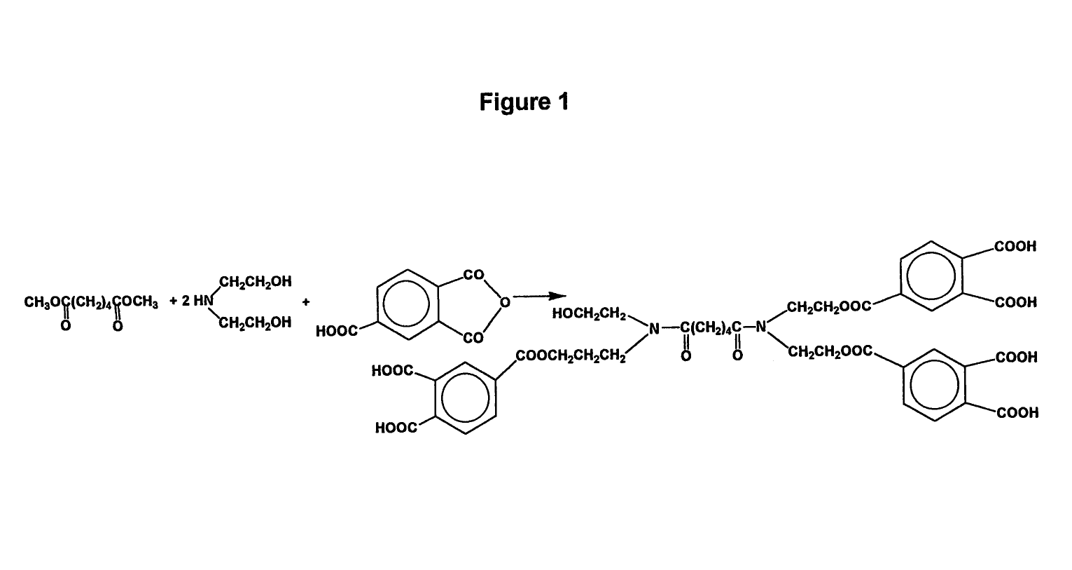

Specific examples falling within Formula II are bis[N,N-di(β-hydroxyethyl)]adipamide, bis[N,N-di(β-hydroxypropyl)]succinamide, bis[N,N-di(β-hydroxyethyl)]azelamide, bis[N-N-di(β-hydroxypropyl)]adipamide, and bis[N-methyl-N-(βhydroxyethyl)]oxamide. A method for making a suitable hydroxyalkylamide is illustrated in FIG. 1.

Specific β-hydroxyalkylamides also are those of the foregoing Formula III where A is a polyester polymer chain which is either linear or branched, where optionally the chain contains ester-amide groups. Accordingly, A can additionally comprise ester amides alternating along a polymeric backbone, or in the case of a branched structure, the ester and amide linkages alternate among the main and side chains of the branched structure.

Other Reactive Functional Group

The β-hydroxyalkylamide selected and/or prepared is then reacted with a compound bearing functional groups or precursors to functional groups other than a hydroxyalkylamide group. That compound is a monomer, oligomer or polymer which in addition to the group which is not a hydroxyalkylamide, contains at least one functional group that can react with a hydroxyalkylamide group. In some cases, the compound bearing the functional groups or precursors to functional groups may after reaction with a suitable hydroxyalkylamide compound be subject to polymerisation to produce the final condensation product bearing the desired functional groups.

Compounds bearing such functional groups or precursors to such functional groups include cyclic anhydrides, monomeric or polymeric polycarboxylic acids or polycarboxylic acid anhydrides containing one or more anhydride groups per molecule and one or more free carboxylic acid groups per molecule, which after reaction with the β-hydroxyalkylamide, results in free carboxylic acid groups remaining. Specific examples of carboxylic acids and anhydrides include, but are not limited to, adipic acid, decanedicarboxylic acid, trimellitic anhydride, phthalic acid or phthalic anhydride, tetrahydrophthalic acid or tetrahydrophthalic anhydride, hexahydrophthalic acid, tetrahydrophthalic anhydride, tetrahydrophthalic acid, hexahydrophthalic anhydride, pyromellitic acid, pyromellitic anhydride, 3,3′,4,4′-tetra-benzophenone carboxylic acid anhydride and combinations thereof.

Other suitable carboxylic acid compounds are, for example, dimer or trimer acids of saturated aliphatic (C₁-C₂₆) acids, unsaturated (C₁-C₃₆) fatty acids, hydroxycarboxylic acids and polyhydroxycarboxylic acids such as 2,2-bis-(hydroxymethyl)-propionic acid as well as α,β-unsaturated acids.

Examples of suitable α,β-unsaturated acids are (meth)acrylic acid, crotonic acid and monoesters or monoamides of itaconic acid, maleic acid, 12-hydroxystearic acid, polyether carboxylic acid, and fumaric acid.

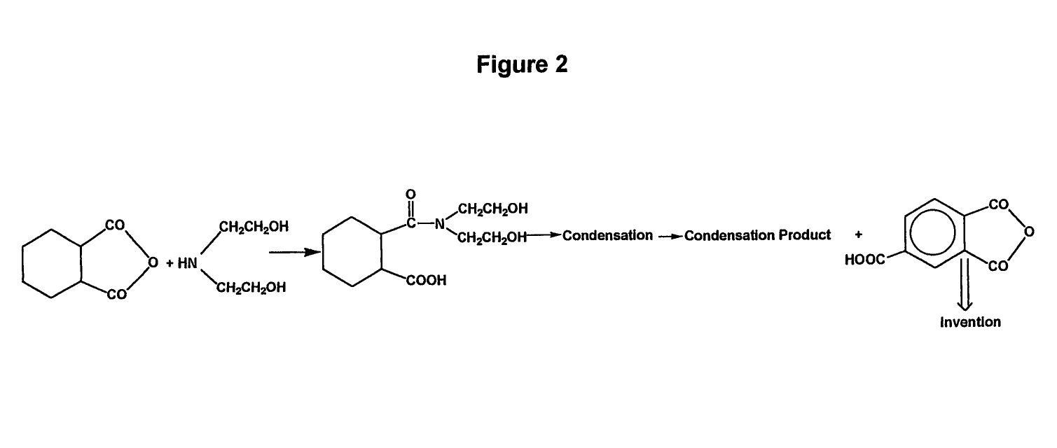

When polycarboxylic acids are used, the functional groups on the final condensation product of this invention would be predominantly free carboxylic acid groups. The use of cyclic anhydrides or polycarboxylic acid anhydrides on the other hand allows selective reaction of the anhydride groups with the β-hydroxyalkylamide groups under conditions such that the free carboxylic acid groups are substantially unreactive. In this way, compounds containing both types of groups can be prepared. FIG. 2 illustrates a method for making the final ester-amide condensation product of the invention using anhydrides.

Examples of other suitable reactive groups include, but are not limited to, isocyanate groups, epoxy groups, alkoxysilane groups, acid chloride groups, epoxychlorohydrine groups, amine groups, phenolic groups, methylolated amide groups, hydroxyl groups, methylol groups and combinations hereof.

Examples of suitable isocyanates include, but are not limited to, diisocyanates such as 1,4-diisocyanato-4-methyl-pentane, 1,5-diisocyanato-5-methylhexane, 3(4)-isocyanatomethyl-1-methylcyclohexylisocyanate, 1,6-diisocyanato-6-methylheptane, 1,5-diisocyanato-2,2,5-trimethylhexane and 1,7-diisocyanato-3,7-dimethyloctane, and 1-isocyanato-1-methyl-4-(4-isocyanatobut-2-yl)-cyclophexane, 1-isocyanato-1,2,2-trimethyl-3-(2-isocyanato-ethyl)-cyclopentane, 1-isocyanato-1,4-dimethyl-4-isocyanatomethyl-cyclohexane, 1-isocyanato-1,3-dimethyl-3-isocyanatomethyl-cyclohexane, 1-isocyanatol-n-butyl-3-(4-isocyanatobut-1-yl)-cyclopentane and 1-isocyanato-1,2dimethyl-3-ethyl-3-isocyanatomethyl-cyclopentane, respectively.

In the event oligomeric or polymeric esters are used to prepare the β-hydroxyalkylamide compound, such derivatives may be reacted with cyclic anhydrides, polycarboxylic acids or polycarboxylic acid anhydrides just as when using monomeric esters.

In the event the initially formed β-hydroxyalkylamide compound contains more than two β-hydroxyalkylamide groups per molecule, one or more such groups can be blocked by reaction with a suitable monofunctional reagent such as a monofunctional carboxylic acid prior to reaction with a polycarboxylic acid or a polycarboxylic acid anhydride or other desirable reactive groups.

Thus, the methods essentially involve preparing a monomeric ester-amide, or an oligomeric or polymeric ester-amide of non-linear structure with terminal β-hydroxyalkylamide groups and subsequently reacting at least 50%, of those terminal groups with cyclic anhydrides, polycarboxylic acids, polycarboxylic acid anhydrides, or other suitable compounds as described above depending on the desired structure and functional group, where the various reactions may be carried out in one or more steps according to well known polymerization and sequential functionalization techniques.

Condensation Product

In general, the average number (mole basis) of desired functional groups per molecule or “functionality” present in the condensation product of this invention after reacting the β-hydroxyalkylamide with, for example, cyclic anhydrides, can range from 4 to 48, preferably at least 8, and more preferably in the range of 8-24 functional groups per molecule, but whereby not more than 50% of the total number of functional groups per molecule are β-hydroxyalkylamide groups. In other words, at least fifty percent of the functional groups (on a mole basis) are groups other than a β-hydroxyalkylamide group. Desired functional group content by weight ranges from 50 to 750 mgKOH/g.

The number average molecular weight of the final condensation product ranges from 300 to 15,000, preferably 1000-5000.

As indicated earlier, the reactive functional groups on the final molecule of the condensation product are selected depending on the particular polymer binder of the powder coating in which the product will be added as a matting agent. The binders typically used in powder coatings include, but are not limited to, epoxy-polyesters, epoxies, polyesters, polyester-acrylics, polyester-primids, polyurethane, and acrylics. Epoxy-polyesters are frequently used binders, and carboxylic functionality would be a preferred reactive functional group for a matting agent intended for such binders.

The condensation product may be prepared in the melt phase, or may be prepared in a suitable organic solvent, for example an aprotic solvent such as dimethylacetamide or N-methyl-2-pyrrolidone.

Solvents such as N-methyl-2-pyrrolidone can subsequently be removed by distillation. However, due to the high boiling point and high heat of vaporization, large amounts of energy would be needed for this operation. Moreover, it is usually difficult to ensure substantially complete removal of such solvents in this way due to the strong interactions existing between the solvent and the solute. An alternative method is to extract the solvent into a second solvent such that the solute is not soluble in the solvent mixture. A suitable second solvent in many of the present cases is water, but may for example also be alcohols or water-alcohol mixtures. Further counter-current washing of the precipitated product with water or the second solvent may be carried out as necessary to ensure substantial removal of the first solvent.

The solvent solution of the product may be added under intense stirring to the second solvent, for example as droplets or as a continuous stream of material such that the precipitated product is present substantially in a particulate form. In some cases, this process may be aided by the presence of an inorganic solid. This is particularly helpful, if the precipitated organic product does not have a solid-like character. The resulting product may finally be dried at temperatures not exceeding 100° C.

Drying at temperatures above the glass transition temperature of the condensation product can lead to the product flowing and binding any inorganic components that may be present, resulting in bonded agglomerates. In this form, the condensation product may not readily dissolve in otherwise suitable solvents and may not readily disperse throughout the powder coating during extrusion. With certain embodiments it may be preferable to obtain the condensation product in the pure state (without inorganic particulate) by the above method of solvent extraction. In this case, the particulate form resulting from the procedure may be lost if the drying temperature is too high.

In order to avoid these problems, when the product is dried it is preferable to dry it under reduced pressure. This may for example be carried out in a vacuum oven or in a rotational evaporator equipped with facilities for application of a vacuum. A final rinse with a volatile water miscible solvent such as acetone, methyl ethyl ketone, methanol, ethanol or isopropanol after water washing such that the final solvent does not dissolve the organic component may be carried out prior to drying. Alternatively, the product may be reslurried/redissolved in solvents such as acetone, methyl ethyl ketone, methanol, ethanol or isopropanol, in water or in combinations thereof and the product recovered by drying.

Either of the above problems may also be avoided by spray drying a solution of product together with an inorganic solid if desired in order to obtain a final product having a suitable particulate form. Suitable solvents may for example be selected from alcohols, water/alcohol mixtures and ketones.

The overall approach therefore avoids high temperatures that would otherwise make it difficult to prepare compounds containing two or more types of functional groups that are reactable with one another. Any esterification and transesterification catalysts that are used during the chemical reactions leading to the final product can also be extracted to the extent that they are soluble in the second solvent and to the extent that their removal is desirable.

Where the condensation product is prepared entirely in the melt phase, obtaining the product in a suitable particulate form for incorporation into the powder coating could be achieved by the techniques mentioned above. For example, the melt could be run into a stirred non-organic solvent such as water, or the-material could be dissolved in a suitable solvent and the resulting solution spray dried. However, the most straightforward procedure would be to cool the product and to simply pulverize the solidified material to a suitable particle size.

In an alternative procedure, it may be possible in some cases to blend the reagents together in an aqueous or organic solvent phase including any inorganic solid to be present in the final product as required, dry the resultant mixture and complete any remaining reaction or polymerization steps in the solid state.

Where the condensation product is to be combined with a matte activator, described below, the matte activator may be added at any suitable step in the above reaction and processing sequence. Typically, the matte activator is added during the slurrying or redissolution steps that precede drying.

In any of the above instances, a suitable average particle size for the final matting agent product in order to facilitate it into the final powder coating mixture is regarded as ranging from about 1 μm to about 100 μm and preferably not greater than 50 μm. The final product may subsequently be pulverized or milled if required. Any final milling step should be carried out at suitably low temperatures in the event only condensation product is in the final matting agent product.

The amount of condensation product added to the powder coating depends on the amounts of other additives included in the powder formulation, e.g., other additives such as a matte activator and other optional additives discussed below. In general, the amounts of condensation product to be added can range from about 0.5% to 20% based on the total weight of the powder coating formulation. Preferably the amount ranges from about 1% to 10% based on the weight of binder in the powder coating formulation.

A mixture of different condensation products, each falling within the scope of the invention may also be employed in the powder coating formulation.

In certain stances, it is also suitable to combine the invention with β-hydroxyalkylamides containing more than 50% β-hydroxyalkylamide functionality insofar as the overall active functionality of the combination comprises no more than 50% β-hydroxyalkylamide.

Inorganic Particulate Additives

Inorganic particulates suitable for incorporation with the condensation product include those inorganic-based matting agents employed in conventional solvent borne coatings.

Silica particulates are suitable. These particulates range in average particle size from 1 to 20 microns, preferably 5 to 10 microns. Porous silicas are usually preferred for their matting efficiency and have pore volumes ranging from 0.5 to 2.0 cc/g, preferably 1.0 to 2.0 cc/g. Particle sizes mentioned above are those reported using a Coulter Counter and the pore volume is that obtained using nitrogen porosimetry. Suitable silicas and methods for making them are described in U.S. Pat. No. 4,097,302, the contents of which are incorporated by reference. Particulated aluminum oxide or metal silicates and aluminosilicates in the size ranges above are also suitable.

Inorganic particulates can be present in a range of 0 to 2 parts by weight per one part by weight condensation product. Embodiments containing such particulates, however, more typically contain inorganic particulate and condensation product at a ratio of 1:1 parts by weight.

If an inorganic particulate is to be present in the final matting compound together with the condensation, dry-blending or co-milling the two after preparation of the condensation product in particulate form can be carried out. The inorganic component such as a silica or alumina can, if dry, be added at any stage of the reaction sequences leading to the condensation product. As mentioned above, the inorganic component may also be added to the reaction product just prior to a precipitation step, or may be added to a solution or slurry of the condensation product just prior to the final drying step. Where an inorganic component is to be added during the reaction sequences leading to the condensation product, or added prior to precipitation or drying steps, the presence of a solvent or carrier medium such as those mentioned earlier may, for rheological reasons be helpful.

The final product may subsequently be pulverized or milled as required. The final product should be milled to that having an average particle size suitable for facilitating it into the final powdered coating mixture. Suitable average particle sizes for the final matting agent product range from about 1 μm to about 50 μm.

Matte Activator

As indicated above, matte activators may also be used in combination with condensation product of this invention to prepare a preferred matting agent. A matte activator includes, but is not limited to, compounds such as catalysts or coreactants known in the art. These activators accelerate or facilitate matting, facilitate curing of the powder coating to which the invention is added and promote formation of films having the desired properties. The selected activator depends on the binder in the powder coating. A catalyst suitable as an activator hereunder can be defined as a compound left unchanged after the reaction of the invention and powder coating binder and is usually used in relatively small amounts. A coreactant suitable hereunder, which may be present in varying amounts, is used up as it participates and is usually consumed in the aforementioned reaction. Quaternary phosphonium halides and quaternary phosphonium phenoxides and carboxylates such as those described in EP 019 852 or U.S. Pat. No. 4,048,141, the contents of which are incorporated herein by reference, are particularly suitable matte activators.

Preferred phosphonium-based matte activators are represented by the formula (V): 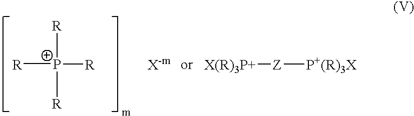
wherein each R is independently a hydrocarbyl or inertly substituted hydrocarbyl group, Z is a hydrocarbyl or inertly substituted hydrocarbyl group and X is any suitable anion.

The term “hydrocarbyl” as employed herein means any aliphatic, cycloaliphatic, aromatic, or aliphatic or cycloaliphatic substituted aromatic groups. The aliphatic groups can be saturated or unsaturated. Those R groups which are not aromatic contain from 1 to 20, preferably from 1 to 10, more preferably from 1 to 4 carbon atoms.

The term “inertly substituted hydrocarbyl group” means that the hydrocarbyl group can contain one or more substituent groups that does not enter into the reaction and does not interfere with the reaction between the epoxy compound and the polyester. Suitable such substituent groups include for example, NO₂, Br, Cl, I, F.

Suitable anions include, but are not limited to, halides such as, for example, chloride, bromide, iodide and the carboxylates as well as the carboxylic acid complexes thereof, such as formate, acetate, propionate, oxalate, trifluoroacetate, formateformic acid complex, acetateacetic acid complex, propionatepropionic acid complex, oxalateoxalic acid complex, trifluoroacetatetrifluoroacetic acid complex. Other suitable anions include, for example, phosphate, and the conjugate bases of inorganic acids, such as, for example, bicarbonate, phosphate, tetrafluoroborate or biphosphate and conjugate bases of phenol, such as, for example phenate or an anion derived from bisphenol A.

Some of the catalysts are commercially available; however, those which are not can be readily prepared by the method described by Dante et al. in the aforementioned U.S. Pat. No. 3,477,990, by Marshall in the aforementioned U.S. Pat. No. 4,634,757 and by Pham et al. in the aforementioned U.S. Pat. No. 4,933,420. Examples of the above-mentioned phosphonium catalysts include, among others, methyltriphenylphosphonium iodide, ethyltriphenylphosphonium iodide, propyltriphenylphosphonium iodide, tetrabutylphosphonium iodide, methyltriphenylphosphonium acetateacetic acid complex, ethyltriphenylphosphonium acetateacetic acid complex, propyltriphenylphosphonium acetateacetic acid complex, tetrabutylphosphonium acetateacetic acid complex, methyltriphenylphosphonium bromide, ethyltriphenylphosphonium bromide, propyltriphenylphosphonium bromide, tetrabutylphosphonium bromide, ethyltriphenylphosphonium phosphate, benzyl-tri-para-tolylphosphonium chloride, benzyl-tri-para-tolylphosphonium bromide, benzyl-tri-para-tolylphosphonium iodide, benzyl-tri-meta-tolylphosphonium chloride, benzyl-tri-meta-tolylphosphonium bromide, benzyl-tri-meta-tolylphosphonium iodide, benzyl-tri-ortho-tolylphosphonium chloride, benzyl-tri-ortho-tolylphosphonium bromide, benzyl-tri-ortho-tolylphosphonium iodide, tetramethylene bis(triphenyl phosphonium chloride), tetramethylene bis(triphenyl phosphonium bromide), tetramethylene bis(triphenyl phosphonium iodide), pentamethylene bis(triphenyl phosphonium chloride), pentamethylene bis(triphenyl phosphonium bromide), pentamethylene bis(triphenyl phosphonium iodide), hexamethylene bis(triphenyl phosphonium chloride), hexamethylene bis(triphenyl phosphonium bromide), hexamethylene bis(triphenyl phosphonium iodide), or any combination thereof.

Particularly suitable phosphonium compounds which can be employed herein include, for example, methyltriphenylphosphonium iodide, ethyltriphenylphosphonium iodide, tetrabutylphosphonium iodide, methlytriphenylphosphonium acetateacetic acid complex, ethyltriphenylphosphonium acetateacetic acid complex, tetrabutylphosphonium acetateacetic acid complex, methyltriphenylphosphonium bromide, ethyltriphenylphosphonium bromide, tetrabutylphosphonium bromide, ethyltriphenylphosphonium phosphate, benzyl-tri-para-tolylphosphonium chloride, benzyl-tri-para-tolylphosphonium bromide, benzyl-tri-para-tolylphosphonium iodide, benzyl-tri-meta-tolylphosphonium chloride, benzyl-tri-meta-tolylphosphonium bromide, benzyl-tri-meta-tolylphosphonium iodide, benzyl-tri-ortho-tolylphosphonium chloride, benzyl-tri-ortho-tolylphosphonium bromide, benzyl-tri-ortho-tolylphosphonium iodide or any combination thereof.

Tertiary amine and quaternary ammonium halide catalysts are suitable when preparing matting agents for powder coatings involving the reaction of an epoxy group and a carboxylic group containing compound.

Esterification and transesterification catalysts such as metal alkoxides and metal carboxylates are suitable for use with matting agents of this invention designed for polyester primid coatings.

As indicated above, it has been discovered that these substances enhance the degree of matting attained at a given addition level of matting agent. Typically the matte activator would be added by blending one or more, e.g., catalyst and/or coreactants with the final condensation product. That would generally require adding by weight of the condensation product, 1 to 50% and more typically 5 to 33% of catalyst or co-reactant , i.e., a ratio of condensation product to catalyst and/or co-reactant of 100:1 to 1:1 and more typically 20:1 to 2.1. A ratio of condensation product to catalyst and/or co-reactant of approximately 4:1 to 6:1 is preferred.

Accordingly a preferred embodiment of the inventive product comprises (1) an ester amide condensation product described above, and (2) an inorganic solid and/or matte activator compound.

Other Optional Additives

If so desired, additives such as those used in conventional powder coatings can be combined with the condensation product according to the invention. Such additives include, for example, pigments, fillers, degassing agents, flow agents and stabilizers. Suitable pigments are for example inorganic pigments, such as for example titanium dioxide, zinc sulphide, iron oxide and chromium oxide, and also organic pigments such as for example azo compounds and phthalocyanine compounds. Suitable fillers are for example metal oxides, silicates, carbonates and sulphates.

Primary and/or secondary antioxidants, UV stabilizers such as quinones, (sterically hindered) phenolic compounds, phosphonites, phosphites, thioethers and HALS compounds (hindered amine light stabilizers) can for example be used as stabilizers.

Examples of degassing agents are benzoin and cyclohexane dimethanol bisbenzoate. The flow agents include for example polyalkylacrylates, polyvinyl acetyls, polyethyleneoxides, polyethyleneoxide/propyleneoxide copolymers, fluorohydrocarbons and silicone fluids.

Any optional additives and the condensation product can then be blended into the powder coating mixture using conventional means. The final matting agent composition can be incorporated as a dry blend with the powder coating binder, or it can be combined with those binders in, for example an extruder, to form particles containing binder, matting agent and any other additive introduced into the extruder.

Matting Mechanism

Generally speaking, matting products used in traditional solvent borne coatings are not widely successful when used in powder coatings primarily because those products are not compatible with or designed to specifically function within the mechanism in which powder coatings form a film. It has been found that while traditional matting products can reduce gloss, more often than not they cause film imperfections and other film failures.

More particularly, powder coatings are designed to flow during heating. As a result, the selection of polymers and crosslinkers for those coatings are based on molecular weight, degree of branching and functionality so that after application of the solid powder particles to a suitable substrate, usually a metallic substrate, the individual polymer particles can collapse together and coalesce during heating. Crosslinking reactions occur subsequently, so that a smooth, continuous and hard film of good quality is formed. Particle collapse and flow of the initial dry powder structure can occur quite rapidly and a glossy surface is observed within a minute or two at normal cure temperatures, e.g., 120-200° C.

At the stage when the film first shows a glossy finish, surface roughness is still present. Indeed, the height roughness may be quite large at this stage. However, the slope of the roughness is expected to determine the gloss, so that if the wavelength is large enough, the perception of a glossy surface will be provided. During further heating and continuing coalescence, the slope of the surface roughness may stay approximately the same and the film stays glossy.

On the other hand, if the powder coating particles do not have sufficient opportunity to flow, e.g., flow is physically impaired, a textured surface may develop, or alternatively, visually rough surfaces with poor film properties may be obtained. Traditional matting products may be used to reduce the gloss of powder coatings to some extent, but as indicated above this approach is normally limited to low volume amounts and when gloss levels above 60 units at 60° are acceptable. Even then, impairment of film properties may result.

Physical flow impairment is also regarded as occurring if the molecular weight of the binder polymer is too high, or if the functionality of the polymer or crosslinker is too high. Particles sizes of the binder polymer also can be large enough to impair coalescence and subsequent flow.

However, moderately hindered flow should permit the slope of the surface roughness to increase during heating following the stage of initial flow and coalescence so that a matt surface can be created from an initially glossy one, since at this stage, flow processes are still occurring.

Accordingly, and without being held to any particular theory, a suitable matting agent for powder coatings should be able to provide for an increase in the slope of the surface roughness of the powder coating during film formation as a result of chemical reaction. More specifically, a suitable matting agent hinders coating flow after the powder has formed the initial glossy state. This may occur by means of molecules having a suitable density and distribution of reactive groups. These methods can be classified as essentially chemical or reactive in nature as opposed to the essentially physical or non-reactive methods associated heretofore with the use of typical fillers and waxes.

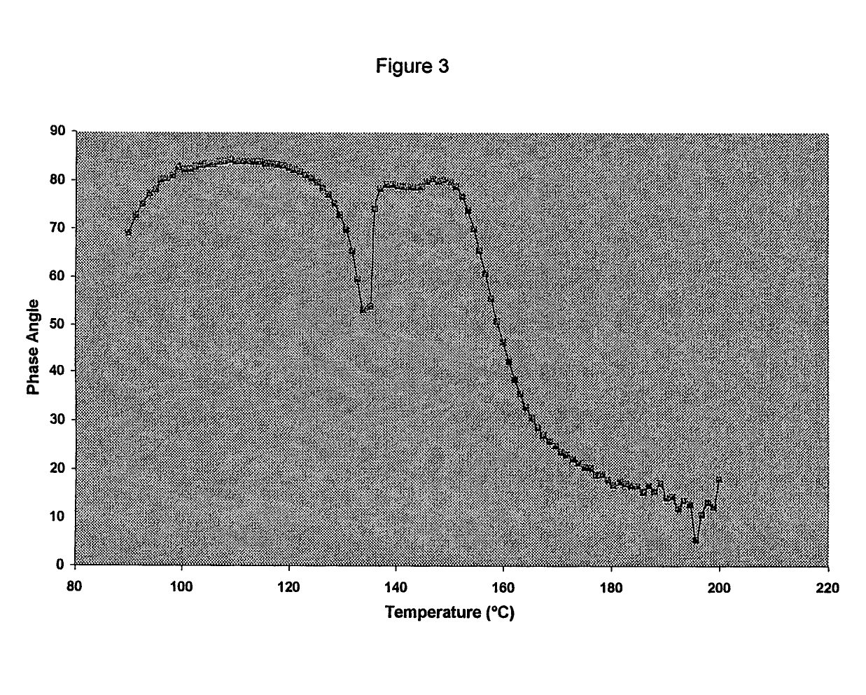

However, care should be taken not to introduce compounds that result in a high degree of flow inhibition or are so reactive that significant network formation occurs too early in the curing schedule of the powder coating, as this may negatively influence film appearance and film properties as described earlier. FIG. 3 shows linear viscoelastic properties of a powder coating cured with crosslinking agents containing only β-hydroxyalkylamide groups. Following an initial decrease in the phase angle as crosslinking reactions begin, at a temperature of 140° C. the phase angle starts to increase again indicating an increase in fluidity, before dropping again at 160° C. as the material solidifies and chemical reactions go towards completion.

Without being held to a particular theory, this may arise as a result of free COOH or OH groups attacking the ester linkage proximally located by the amide group, by transesterification, leading to a temporary decrease in molecule weight, prior to the final molecular weight build-up at higher temperatures as indicated by approach of the phase angle to 0°. This may explain why compounds with a large number of β-hydroxyalkylamide groups per molecular are nevertheless capable of producing glossy powder coating films of good quality.

This data therefore indicates that if the proportion of β-hydroxyalkylamide groups to total functional groups per molecule is too high then matting will not be possible. On the other hand, the functionality content of the inventive composition minimizes that effect because not more than 50% of the total number of functional groups per molecule may be β-hydroxyalkylamide groups. The implication is therefore that the invention is associated with maintaining sufficient flow and reactive capability to produce powder coating films with good appearance and film properties but consistent with the powder coating film being matte. The invention can also avoid the need to adjust the ratio of resin to crosslinker in the base powder coating formulation, which would also be helpful in maintaining film properties insofar that dual functionality is intentionally built into a given compound.

The aminoalcohols and carboxylic acid compounds employed in preparing the ester and ester-amide condensation products of this invention can vary and accordingly this invention offers a large number of ways to produce the desired sometimes dual functionality of this invention. Accordingly, the compounds of this invention can even be combined with conventional β-hydroxyalkylamide crosslinkers of the types disclosed in patents referred to above to obtained the desired dual functionality and thus offer additional compounds to control film properties (other than matte) of matted coatings.

The preferred embodiments, and modes of operation of the present invention have been described in the foregoing specification. The invention which is intended to be protected herein, however, is not to be construed as limited to the particular embodiments disclosed, since they are to be regarded as illustrative rather than restrictive. Variations and changes, therefore, may be made by those skilled in the art without departing from the spirit of this invention. Further, any range of numbers recited in the specification or claims, such as that representing a particular set of properties, conditions, physical states or percentages, is intended to literally and expressly incorporate herein any number falling with such range, including any subset ranges of numbers with a range so recited. The examples given below therefore only illustrate preparation of the matting compounds described herein and tested in the particular powder coatings mentioned below in order to merely illustrate gloss reductions of powder coatings by means of the chemistry discussed above.

### SPECIFIC EXAMPLES

The powder coating employed is indicated below and represents a typical epoxy-polyester coating. The matting compounds were added so as to give a volume fraction in the coating of around 0.05 in most cases, with the proportion of polyester and epoxy being simultaneously adjusted as needed to accommodate the functionality of the matting compounds.

As a reference point, Ciba 3557, a commercially available reactive matting agent was used in the same way with simultaneous adjustment of the proportion of epoxy and polyester resins. Polyester-Primid powder coatings were also employed.

### Example 1

1 mole of Primid XL552 having four β-hydroxyalkylamide groups per molecule was reacted with 2.5 moles of 1,2,4,5Benzene-tetracarboxylic acid in the presence of silica in the solid state. In this instance, Primid XL552 contains terminal β-hydroxyalkylamide groups and is obtained as discussed earlier by reacting a diester, substantially the dimethyl ester of adipic acid, with two moles of diethanolamine.

Accordingly, 40.3 g of Primid XL552 from Rohm&Haas and 80 g of 1,2,4,5Benzene-tetracarboxylic acid were dissolved in 53.8 g of water. 41 g of (Syloid C807) silica gel having a pore volume of approximately 2 cc/g was added and the mixture was stirred at room temperature for 1 hour. The excess water was removed by heating at 120° C. with application of a vacuum to 300 mmHg whereupon the temperature was raised to 150° C. and maintained for 4 hours to allow reaction to take place.

The acid value of the end product was low and did vary compared to the theoretical value of 279 mgKOH/g. The acid values reported in this Example and those that follow were measured using the following method: About 0.5 g of the sample product is added to 100 ml tetrahydrofuran (THF) and stirred for one hour under mild warming (maximum to 35° C.). The solution is titrated at room temperature with aqueous 0.1M KOH against a phenolphthalein indicator to a pink colored end point from which the acid value AV can be calculated as AV=(5.61 *V)/S where V is the volume in mis of KOH solution and S is the weight of the dry sample. The organic to inorganic ratio was 2.7:1 by weight. The presence of bonded aggregates may explain the discrepancy in acid values. The density of the final solid product was determined by Pykonometry to be 1.57. This density, together with the theoretical acid value, was used for purposes of calculating powder coating formulations.

The product (Product A) was incorporated into a standard polyester-epoxy powder coating at a volume fraction addition level of 0.05. The composition of the coating on a weight basis is given in the table below.

Polyester-Epoxy Powder Coating for Product A

| Component | % by Weight |
|---|---|
| Uralac P5071 (Polyester Resin) | 32.79 |
| Araldite GT7004 (Epoxy Resin) | 34.06 |
| Kronos 2310 (Titanium Dioxide) | 26.66 |
| Product A | 5.23 |
| Byk 365P (Flow Agent) | 0.99 |
| Benzoin (Flow and Degassing Agent) | 0.27 |
| | 100 |

The percentage addition of matting agent by weight was therefore 5.2%, 3.8% of which arose from the organic constituent. The powder coating was prepared and tested under the standard conditions discussed later below.

### Example 2

The commercially available crosslinker Primid XL552 was again employed as a compound containing terminal β-hydroxyalkylamide groups. Primid XL552 was reacted with the anhydride functionality of 1,2,4-benzene-tricarboxylic acid anhydride to produce a substantially monomeric ester-amide containing 8 terminal carboxylic acid groups per molecule and combined with Pural 200 (γ-AlO.OH) alumina. The pore volume of Pural 200 alumina is 0.6 cc/g.

Thus 29.67 g of Primid XL552 were charged to a reaction vessel containing N,N-dimethylacetamide (DMA) and after dissolution, 71.16 g of benzene-1,2,4 tricarboxylic acid 1,2-anhydride were added under stirring. The amount of DMA was selected so that the final concentration was 25% by weight. The mixture was heated to 90° C. for 1 hour. The acid value was determined to be 452 mgKOH/g compared to the theoretical value of 402 mgKOH/g. The method to determine acid value is expected to have an error of about ±5%.

The vessel was charged with 168.05 g of Pural 200 and after through mixing, the contents of the reaction vessel were slowly added to 1 liter of distilled water, preheated to 40° C. The precipitate was separated by filtration and washed three times by reslurrying each time in 1 liter of distilled water preheated to 40° C. The final precipitate was dried at 90° C. for 16 hours and pulverized. The acid value of the final product was determined to be 100 mgKOH/g compared to the theoretical value of 151 mgKOH/g.

Decomposition and removal of the organic component at 950° C. indicated that the percentage of organic compound was close to the theoretical value of 38%. Bonded aggregates may therefore have formed, thereby affecting acid value measurement. The density of the final solid product was determined by Pykonometry to be 2.1 and this, together with the theoretical acid value was used for purposes of calculating powder coating formulations.

The product (Product B) was incorporated into a standard polyester-epoxy powder coating at a volume fraction addition level of 0.05. The composition of the coating on a weight basis is given in the table below.

Polyester-Epoxy Powder Coating for Product B

| Component | % by Weight |
|---|---|
| Uralac P5071 (Polyester Resin) | 35.74 |
| Araldite GT7004 (Epoxy Resin) | 29.92 |
| Kronos 2310 (Titanium Dioxide) | 26.20 |
| Product B | 6.88 |
| Byk 365P (Flow Agent) | 0.27 |
| Benzoin (Flow and Degassing Agent) | 0.99 |
| | 100 |

The percentage addition of matting agent by weight was therefore 6.9%, 2.6% of which arose from the organic constituent. The powder coating was prepared and tested under the standard conditions discussed below.

### Example 3

By an alternative method, a non-linear polymeric ester-amide with terminal carboxylic acid groups and only terminal amide groups was prepared by transesterifying 4.5moles of dimethyl adipate with 1 mole of trimethylolpropane, subsequent reaction of the remaining ester groups with 6 moles of diethanolamine, followed by further reaction with 12 moles of 1,2,4-benzene tricarboxylic acid anhydride. Thus, 10.3 g of trimethylolpropane was melted at a temperature of 60° C. and charged to a reactor. 60.1 g of dimethyladipate was blended in followed by 0.1 g of a transesterification catalyst.

Under a nitrogen atmosphere, the temperature was raised to 120° C. and then again gradually to 150° C. and held there for a period of 4 hours. A vacuum of 300 mmHg was applied and held for a further four hours. The distillate had a refractive index of 1.3369, indicating methanol. The reactor was subsequently charged with 48.4 g of diethanolamine and under a nitrogen atmosphere, heated at 120° C. for four hours. A vacuum of 300 mmHg was applied and the resulting distillate had a refractive index of 1.3358, indicating methanol.

176.8 g of 1,2,4-benzene tricarboxylic acid anhydride dissolved in 296 g of dimethylacetamide was added to the reactor and the mixture was heated under reflux for a period of four hours at 90° C. The acid value was determined to be 399 mgKOH/g compared to the theoretical value of 377 mgKOH/g.

The vessel was charged with 493 g of Pural 200 and after through mixing, the contents of the reaction vessel were slowly added to 2.5L of distilled water at room temperature. The precipitate was separated by filtration and washed three times by reslurrying each time in 2.5L of distilled water. The final precipitate was dried at 95° C. for 16 hours and pulverized. The acid value of the final product was determined to be 77 mgKOH/g compared to the theoretical value of 125 mgKOH/g.

Decomposition and removal of the organic component at 950° C. indicated that the percentage of organic compound was at 33%, close to the theoretical value of 38%. Bonded aggregates may therefore have formed, thereby likely causing the measured acid value to vary from the theoretical acid value. The density of the final solid product was determined by Pykonometry to be 2.04 and this, together with the theoretical acid value was used for purposes of calculating powder coating formulations.

The product was labeled product C and its behavior was assessed in a standard polyester-epoxy powder coating at a volume fraction addition level of 0.05. The composition of the coating on a weight basis is given in the table below.

Polyester-Epoxy Powder Coating for Product C

| Component | % by Weight |
|---|---|
| Uralac P5071 (Polyester Resin) | 38.11 |
| Araldite GT7004 (Epoxy Resin) | 28.51 |
| Kronos 2310 (Titanium Dioxide) | 26.60 |
| Product C | 6.78 |
| | (2.6 organic) |
| Byk 365P (Flow Agent) | 0.28 |
| Benzoin (Flow and Degassing Agent) | 1.00 |
| | 100 |

The percentage addition of matting agent by weight was therefore 6.8%, 2.6% of which arose from the organic constituent. The powder coating was prepared and tested under the standard conditions discussed below.

### Example 4

To illustrate the effect of catalysts and co-reactants, the matting compound described in Example 1 and labeled product A, was tested in combination with tetrabutylphosphonium bromide according to the formulation given below.

Polyester-Epoxy Powder Coating for Product
A with tetrabutylphosphonium bromide

| Component | % by Weight |
|---|---|
| Uralac P5071 (Polyester Resin) | 28.22 |
| Araldite GT7004 (Epoxy Resin) | 36.41 |
| Kronos 2310 (Titanium Dioxide) | 26.86 |
| Product A | 5.27 |
| Tetrabutylphosphonium bromide | 1.95 |
| Byk 365P (Flow Agent) | 0.99 |
| Benzoin (Flow and Degassing Agent) | 0.30 |
| | 100 |

As before, the percentage addition of matting agent arising from the organic component amounted to 3.9%. The powder coating was prepared and tested under the standard conditions discussed below.

### Example 5

As a further illustration of the effect of catalysts and co-reactants, the matting compound described in Example 3 and labeled product C, was also tested in combination with tetrabutylphosphonium bromide according to the formulation given below.

Polyester-Epoxy Powder Coating for Product
C with tetrabutylphosphonium bromide

| Component | % by Weight |
|---|---|
| Uralac P5071 (Polyester Resin) | 33.14 |
| Araldite GT7004 (Epoxy Resin) | 30.41 |
| Kronos 2310 (Titanium Dioxide) | 26.49 |
| Product C | 6.78 |
| Tetrabutylphosphonium bromide | 1.92 |
| Byk 365P (Flow Agent) | 0.99 |
| Benzoin (Flow and Degassing Agent) | 0.30 |
| | 100 |

As before, the percentage addition of matting agent arising from the organic component amounted to 2.6%. The powder coating was prepared and tested under the standard conditions discussed below.

### Example 6

As a further example of a non-linear polymeric ester-amide with terminal carboxylic acid groups but containing a greater amount of amide groups per molecule than in Example 3, 1 mole of hexahydrophthalic anhydride was reacted with 1.2moles of diisopropanolamine and subsequently reacted with 1.2 moles of 1,2,4-benzene tricarboxylic acid anhydride. In this instance, the material was prepared without combination with silica or alumina.

Thus 77 g of hexahydrophthalic acid was heated at a temperature of 45° C. and added to a reactor. 80 g of diisopropanolamine dissolved in 40 g of N-methylpyyrrolidone at the same temperature was subsequently blended in. The temperature was raised to 90° C. and the components allowed to react under reflux in a nitrogen atmosphere for 1 hour with constant stirring. Thereupon, a distillation head was fitted to the apparatus and the temperature slowly raised to 160° C. Distillation was continued for 3 hours, until an acid value of <2 mgKOH/g was attained indicating greater than 98% reaction.

The apparatus was converted back to reflux, 115.2 g of 1,2,4-benzene tricarboxylic acid 1,2-anhydride dissolved in 232 g of N-methylpyrrolidone was added to the reactor and the mixture was heated under reflux for a period of four hours at 90° C. in a nitrogen atmosphere. The acid value was determined to be 270 mgKOH/g compared to the theoretical value of 256 mgKOH/g.

The contents of the reaction vessel were slowly added in a continuous stream to 2.5L of distilled water at room temperature under intense stirring. The precipitate was separated by filtration and washed three times by reslurrying each time in 2.5L of distilled water. The final precipitate was dried at 35° C. for 16 hours under vacuum and pulverized. The acid value of the final product was determined to be 246 mgKOH/g compared to the theoretical value of 256 mgKOH/g.

The product was labeled product D and its behavior was assessed in a standard polyester-epoxy powder coating together with tetrabutylphosphonium bromide. The composition of the coating on a weight basis is given in the table below.

Polyester-Epoxy Powder Coating for Product D

| Component | % by Weight |
|---|---|
| Uralac P5071 (Polyester Resin) | 32.88 |
| Araldite GT7004 (Epoxy Resin) | 32.35 |
| Kronos 2310 (Titanium Dioxide) | 27.06 |
| Product D | 5.19 |
| Tetrabutylphosphonium bromide | 1.04 |
| Byk 365P (Flow Agent) | 0.99 |
| Benzoin (Flow and Degassing Agent) | 0.49 |
| | 100 |

The powder coating was prepared and tested under the standard conditions discussed below.

### Example 7

### Comparison 1

As a reference point, the commercially available product Ciba 3357 was tested in the standard polyester-epoxy powder coating at a volume fraction of 0.04. The formulation employed is given below.

Reference Polyester-Epoxy Powder Coating for Ciba 3357

| Component | % by Weight |
|---|---|
| Uralac P5071 (Polyester Resin) | 27.06 |
| Araldite GT7004 (Epoxy Resin) | 40.81 |
| Kronos 2310 (Titanium Dioxide) | 26.89 |
| Ciba 3357 | 3.76 |
| Byk 365P (Flow Agent) | 0.98 |
| Benzoin (Flow and Degassing Agent) | 0.49 |
| | 100 |

The commercially available product was therefore tested at a weight addition level of 3.8%.

### Example 8

### Comparison 2

As a reference point, a standard unmatted polyester-epoxy powder was prepared according to the formulation given below.

Unmatted Polyester-Epoxy Powder Coating

| Component | % by Weight |
|---|---|
| Uralac P5071 (Polyester Resin) | 49.80 |
| Araldite GT7004 (Epoxy Resin) | 22.77 |
| Kronos 2310 (Titanium Dioxide) | 27.42 |
| Byk 365P (Flow Agent) | 1.00 |
| Benzoin (Flow and Degassing Agent) | 0.28 |
| | 100 |

### Example 9

### Comparison 3

As a reference point, a standard unmatted polyester-epoxy powder was prepared containing tetrabutylphosphonium bromide according to the formulation given below.

Unmatted Polyester-Epoxy Powder Coating
containing tetrabutylphosphonium bromide

| Component | % by Weight |
|---|---|
| Uralac P5071 (Polyester Resin) | 44.60 |
| Araldite GT7004 (Epoxy Resin) | 24.76 |
| Kronos 2310 (Titanium Dioxide) | 27.37 |
| Tetrabutylphosphonium bromide | 1.98 |
| Byk 365P (Flow Agent) | 0.99 |
| Benzoin (Flow and Degassing Agent) | 0.3 |
| | 100 |

### Example 10

As an alternative example of a non-linear polymeric ester-amide having terminal carboxylic acid groups, 1 mole of hexahydrophthalic acid was reacted with 1 mole of diethanolamine followed by reaction with 2 moles of cyclopentanetetracarboxylic acid in the solid state in the presence of silica. Thus 61.67 g of hexahydrophthalic acid was melted at a temperature of 45° C. and added to a reactor. 42.1 g of diethanolamine was subsequently blended in.

The temperature was raised to 70° C. and the components allowed to react under reflux in a nitrogen atmosphere for 1 hour with constant stirring. The product had an acid value close to the theoretical value of 217 mgKOH/g. 50.5 g of the reaction product was dissolved in 200 g of water, followed by 95.9 g of cyclopentanetetracarboxylic acid and 88 g of a (Syloid C807) silica gel having a pore volume of approximately 2 cc/g.

The excess water was removed by heating at 120° C. with application of a vacuum to 300 mmHg whereupon the temperature was raised to 150° C. and maintained for 4 hours to allow reaction to take place. The acid value of the end product was determined to be 225 mgKOH/g, about two-thirds of the theoretical value of 330 mgKOH/g. The organic to inorganic ratio was 1.5:1 by weight. The presence of bonded aggregates may have caused the measured acid value to vary from the theoretical acid value. The density of the final solid product was determined by Pykonometry to be 1.57 and this, together with the theoretical acid value was used for purposes of calculating powder coating formulations.

The product was labeled product E and was incorporated into a standard polyester-primid powder coating at a volume fraction addition level of 0.05. The composition of the coating on a weight basis is given in the table below.

Polyester-Primid Powder Coating composition for Product E

| Component | % by Weight |
|---|---|
| Uralac P860 (Polyester Resin) | 61.31 |
| Primid XL 552 (Crosslinker) | 5.78 |
| Kronos 2160 (Titanium Dioxide) | 26.46 |
| Product E | 5.19 |
| Byk 365P (Flow Additive) | 0.27 |
| Benzoin (Flow and Degassing Additive) | 0.99 |
| | 100 |

The percentage addition of matting agent by weight was therefore 5.2%, 3.1% of which arose from the organic constituent. The powder coating was prepared and tested under the standard conditions discussed below.

### Example 11

### Comparison 4

As a reference point, a standard unmatted polyester-primid powder was prepared according to the formulation given below.

Unmatted Polvester-Primid Powder Coating

| Component | % by Weight |
|---|---|
| Uralac P860 (Polyester Resin) | 69.21 |
| Primid XL 552 (Crosslinker) | 3.63 |
| Kronos 2160 (Titanium Dioxide) | 27.16 |
| Byk 365P (Flow Additive) | 1.00 |
| Benzoin (Flow and Degassing Additive) | 0.28 |
| | 100 |

### Example 12

### Gloss and Film Properties of Powder Coatings with Inventive Matting Agent

In all cases, the general procedure for preparing the powder mixtures of the above formulations was as follows. Polyester and epoxy resins or Primid XK552 crosslinker as appropriate, titanium dioxide, flow and degassing additives together with the matting compound and any other additives were charged in the desired amounts to a Prism Pilot 3 premixer and mixed at 2000 rpm for 1 minute. Extrusion was carried out on a Prism 16 mm twin screw extruder with an outlet temperature of 120° C. The extrudate was broken up and milled on a Retsch Ultracentrifugal Mill to an average particle size of about 40μm. Sieving was employed to remove particles above 100 μm.

The white powder coatings were then applied to cold rolled steel test panels (Q-Panel S412) by electrostatic spraying using a Gema PG1 Gun at a tip voltage of 30 kV. The coated panels were cured in an oven at 180° C. for 15 minutes and those panels having film thicknesses in the range of 60-80 μm were selected for testing.

Gloss was determined at 60° by means of a Byk Glossmeter. To assess the extent of chemical reaction following curing of the coatings, the resistance of the film to methyl ethyl ketone (MEK) was determined. This involved rubbing the powder coating film with a cloth soaked in MEK and the resistance was expressed as the number of double rubs required under an approximately 1 Kg load before the underlying metal surface was exposed.

Gardner Impact Testing (ASTM G1406.01) was carried out to assess flexibility. The painted side is facing down into the machine. The point to first cracking and the point at which adhesion loss occurred were. determined. Adhesion loss following impact testing was assessed by applying and removing sticky tape from the impacted region and deciding whether portions of the coating had been removed or not. The results are given in

TABLE 1
Table 1: Gloss levels at 60°, MEK resistance and Impact Resistance
for various compounds added to a standard epoxy-polyester powder
coating (Examples 1-9) or a standard polyester-primid powder coating
(Examples 10-11) and applied to cold rolled steel panels (Q-Panels
S412) at a film thickness of 60-80 μm.

| | | | | Impact | Impact |
|---|---|---|---|---|---|
| | Gloss | Appearance | | Cracking | Adhesion |
| Sample | (60°) | Visual | MEK | (inch · lbs) | (inch · lbs) |
| Example 1 | 34 | Smooth | >100 | <4 | 20 |
| Example 2 | 43 | Smooth | >100 | 10 | 40 |
| Example 3 | 43 | Smooth | >100 | 10 | 100 |
| Example 4 | 7 | Smooth * | >100 | 55 | >160 |
| Example 5 | 29 | Smooth | >100 | 20 | >160 |
| Example 6 | 24 | Smooth | >100 | 120 | >160 |
| Example 7 | 50 | Smooth | 50 | 20 | 120 |
| Comparison 1 | | | | | |
| Example 8 | 92 | Slight orange | >100 | >160 | >160 |
| Comparison 2 | | peel | | | |
| Example 9 | 93 | Slight orange | >100 | >160 | >160 |
| Comparison 3 | | peel | | | |
| Example 10 | 52 | Smooth | >100 | <4 | <4 |
| Example 11 | 95 | Slight orange | >100 | >160 | >160 |
| Comparison 4 | | peel | | | |

* Slight yellowing

Examples 1 to 6 demonstrate clear reductions in gloss with reasonable to good retention of film properties compared to Example 7 and to unmatted coatings represented by Example 8.

Example 8 compared to Example 9, shows that addition of tetrabutylphosphonium bromide to the unmatted powder coating formulation alone has no effect on the gloss levels attained, whereas comparison of Examples 1 and 3 with Examples 4 and 5 demonstrates that improvements in both matting and film properties result when matting agents discussed in this work are combined with such catalysts or coreactants.

### Example 13

### The Effect of Addition Level of the Inventive Matting Agent

To illustrate that gloss values may be adjusted by varying the addition levels of the inventive matting agent, the inventive condensation product represented by Example 6 was tested in an epoxy-polyester powder coating together with a matt activator as before, but at different addition levels of the condensation product, keeping the ratio of the condensation product to matte activator constant. The proportion of polyester and epoxy resins were simultaneously adjusted to accommodate the functionality of the matting compound. The formulations prepared are shown in the table below, where all entries are in percent by weight.

| Component | 1 | 2 | 3 |
|---|---|---|---|
| Uralac P5071 | 49.07 | 38.62 | 32.88 |
| Araldite GT7004 | 22.43 | 29.22 | 32.35 |
| Kronos2310 | 27.02 | 27.01 | 27.06 |
| Product D | — | 3.06 | 5.19 |
| TBPB | — | 0.61 | 1.04 |
| Byk 365P | 0.99 | 0.99 | 0.99 |
| Benzoin | 0.49 | 0.49 | 0.49 |
| | 100 | 100 | 100 |

TBPB = Tetrabutylphosphonium bromide

The results obtained for each of the four formulations are shown in Table 2.

TABLE 2
The effect of addition level of the inventive matting agent
on matting and film properties, where the ratio of the condensation
product to matte activator is held constant

| | | | | Impact | Impact |
|---|---|---|---|---|---|
| | Gloss | Appearance | | Cracking | Adhesion |
| Number | (60°) | Visual | MEK | (inch · lbs) | (inch · lbs) |
| 1 | 92 | Slight Orange | >100 | >160 | >160 |
| | | Peel | | | |
| 2 | 58 | Smooth | >100 | >160 | >160 |
| 3 | 24 | Smooth | >100 | 120 | >160 |

Thus, a decrease in gloss occurs with an increasing proportion of matting compound, coupled with good retention of film properties, demonstrating a further desirable feature of the matting compounds discussed above.

1. Condensation product comprising
(a) at least one ester-amide
(b) optionally, at least one β-hydroxyalkylamide functional group and
(c) at least one reactive functional group other than (b)
wherein (b), if present, constitutes no more than 50% of the total (b) and (c) on a mole basis.

2. Condensation product according to claim 1 wherein (c) is selected from carboxyl, isocyanate, epoxide, hydroxyl and alkoxy silane.

3. Condensation product according to claim 1 wherein the condensation product contains an ester amide selected from the group of monomeric ester-amides, oligomeric ester amides and polymeric ester-amides.

4. Condensation product according to claim 1 wherein (b) is 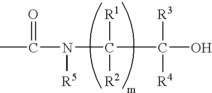
R¹, R², R³ and R⁴ may, independently of one another, be the same or different, H, straight or branched chain alkyl, (C₆-C₁₀) aryl or R¹ and R³ or R² and R⁴ may be joined to form, together with the combinations, a (C₃-C₂₀) cycloalkyl radical; m is 1 to 4 and R⁵ is 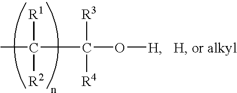
and R¹, R², R³, R⁴ and m as defined above.

5. Condensation product according to claim 4 wherein (c) is selected from carboxyl, isocyanate, epoxide, hydroxyl and alkoxy silane.

6. Condensation product according to claim 1 wherein the condensation product's functional groups consist essentially of (c).

7. Condensation product according to claim 1 having a total functionality on a mole basis in the range of about 4 to about 48.

8. Condensation product according to claim 1 having a functionality on a mole basis of at least 8.

9. Condensation product according to claim 1 having a total functionality on a mole basis in the range of about 8 to about 24.

10. A composition comprising condensation product according to claim 1, wherein said composition comprises inorganic particulate.

11. Composition according to claim 10 wherein the inorganic particulate comprises inorganic oxide.

12. Composition according to claim 10 wherein the inorganic particulate comprises silica or aluminum oxide.

13. Composition comprising condensation product according to claim 1, wherein said composition further comprises a matte activator.

14. Composition according to claim 13 wherein the matte activator is a hydrocarbyl phosphonium salt.

15. A powder coating composition comprising condensation product according to claim 1, wherein said composition further comprises reactive binder.

16. A powder coating composition according to claim 15 wherein the reactive binder comprises a polymer selected from the group consisting of epoxy, epoxy-polyester, polyester-acrylic, polyester-primid, polyurethane and polyacrylic.

17. A powder coating composition according to claim 15 further comprising inorganic particulate.

18. A powder coating composition according to claim 17 wherein the inorganic particulate comprises inorganic oxide.

19. A powder coating composition according to claim 17 wherein the inorganic particulate comprises silica or alumina.

20. A powder coating composition according to claim 15 further comprising matte activator.

21. A powder coating composition according to claim 20 wherein the matte activator is a hydrocarbyl phosphonium salt.

22. A method of matting a powder coating comprising adding inorganic particulate and a condensation product according to claim 1 to a powder coating composition.

23. A method according to claim 22 wherein the inorganic particulate is inorganic oxide.

24. A method according to claim 22 wherein the inorganic particulate comprises silica or aluminum oxide.

25. A method according to claim 22 wherein a matte activator is added to the powder coating composition in addition to the inorganic particulate and the condensation product.

26. A method according to claim 25 wherein the matte activator is a catalyst/coreactant.

27. A method according to claim 22 wherein the powder coating comprises a reactive binder and comprises a polymer selected from the group consisting of epoxy, epoxy polyester, polyester acrylic, polyester primid, polyurethane, and polyacrylic.

28. A method according to claim 26 wherein the catalyst/coreactant is a phosphonium salt of the formula 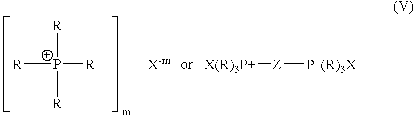
wherein each R is independently a hydrocarbyl or inertly substituted hydrocarbyl group, Z is a hydrocarbyl or inertly substituted hydrocarbyl group and X is any suitable anion.

29. A method according to claim 28 wherein the catalyst/coreactant is a hydrocarbyl phosphonium salt.
